(19) United States
(12) Patent Application Publication
(10) Pub. No.: US 2006/0185221 A1
(43) Pub. Date: Aug. 24, 2006

(54) Fish hook and lure swivel eyelet and method of manufacture

(76) Inventor: Jesse Burns, Las Vegas, NV (US)

Correspondence Address: M. REID RUSSELL, 854 WEST 3390 SOUTH, HURRICANE, UT, 84737, US

(21) Appl. No.: 11/062,246

(22) Filed: Feb. 22, 2005

(51) Int. Cl. A01K 83/00

(52) U.S. Cl. 43/44.83

(57) ABSTRACT

A fish hook or lure swivel eyelet and method of manufacture that allows for a quick and easy mounting of a hook or lure swivel eyelet onto and dismounting it from a fishing line whose end has been knotted. The eyelet is formed from a single section of steel wire as is appropriate to form a fish hook or swivel eyelet, and is slotted thereacross at a selected distance back from a forward end and the forward end portion is bent into a pair of side by side loops with the slot or slots aligning across opposing loop faces to form a slot or hole in the top of the loops that is essentially parallel to the lower portion of the section of steel wire. Which lower portion is formed into a hook or is wrapped around a pivot as a swivel eyelet.

### BACKGROUND OF THE INVENTION

1. Field of the Invention

The present invention relates to fishing devices and in particular to hook and lure swivel eyelets formed to facilitate their attachment onto a fisherman's line.

2. Prior Art

A number of fish hooks, lures and devices have been developed and marketed for use by fishermen for improving a likelihood of, and for simplifying, the catching of fish. All of which have required an attachment of a hook, lure or device onto a fishing line. The invention provides a simplified eyelet arrangement for providing for attachment of a hook, lure swivel or device onto a fishing line.

In an earlier patent of the inventor, U.S. Pat. No. 5,579,600, an eyelet for a fish hook is set out that is functionally similar to the present invention in that it allows for attachment to a fishing line by drawing a knotted end of that line across a separation between parallel loops formed in ends of a hook shank and a separate straight member shank, that have been fixed together, with the line passing into a hole formed across which parallel loops as a slot in each parallel loop opposing surface. The '600 patent, however, presented a necessity for joining, as by brazing, the hook and straight member shanks and forming a hole through the top of the parallel loops. Whereas, the present invention is formed from a single section of wire that is slotted with at least one slot at an appropriate distance back from an outer section of a wire end that is then wound, forming a pair of side by side loops, with the single slot providing passage to a fishing line or leader. Or, where two slots are formed, the slots align with one another at contacting loop surfaces, forming a hole that provides passage to a fishing line or leader and with the slot of hole edge binding to deny passage to a knotted end of which fishing line or leader. The section of wire end that is opposite to the loops end is then formed into a hook, or is fitted to one end of a swivel, or the like. Accordingly, the present invention is easier, simpler in its formation and provides a unique manufacturing process for its formation.

The present invention is an eyelet formed from a single section of wire whose end is formed into a pair of side by side loops, with the outer loop having an open end, and with a hole or slot formed across the loops opposing top surfaces. So arranged, a fishing line with a knotted end is fitted across an open loop end, is pulled between the loops opposing surfaces and into the hole of slot. Which knot is of a diameter to bind against the hole or slot inner edge, preventing passage of the knot and firmly mounting a hook or swivel eyelet. Like the present invention, the earlier hook and swivel device of the '600 patent provided for rapid attachment and removal of a fishing line from a hook end or eyelet and involved a hook or eyelet shank end formed to receive an end of a fishing line that had been tied into a loop. While examples of other hook arrangements are shown in early U.S. Patents to Hudson, U.S. Pat. No. 490,356; to Friend, U.S. Pat. No. 788,201; to O'Brien, U.S. Pat. No. 895,493; and to Heffron, et al. U.S. Pat. No. 2,847,220, none showed the loop arrangement end of a fish hook shank or a lure swivel eyelet like that of the '600 patent or the present invention. Also, where earlier arrangement of fish hooks and swivels have provided for attachment of a knotted end of a fishing line to a hook or swivel eyelet end, such have not involved opposing loops like those of the '600 patent and of the invention. An example of such earlier arrangement is shown in a U.S. Patent to Halferty, U.S. Pat. No. 1,471,959.

### SUMMARY OF THE INVENTION

The invention is in a fish hook and lure swivel eyelet and method of manufacture where a straight section of metal suitable for forming a fish hook or swivel eyelet is wound at one end into a pair of like size, side by side loops, is bent slightly outwardly from an outer loop and the loops have a slot formed through one or both loops that is parallel to straight section of metal that forms the lure shank. The opposite end portion of which straight section of metal is formed into a hook end or is wound around a pivot of a pivoting swivel eyelet, forming a hook or lure swivel eyelet of the invention. Which formation involves notching across the section of wire at a selected distance or distances whereby, when the section of wire end portion is wound to form the side by side loops, the notch or notches align to form the hole or slot between the loops tops that is parallel to the straight section of metal or stiff wire that forms the shank.

It is a principal object of the present invention to provide a fishing hook or lure swivel eyelet end that is manufactured from a single section of a gauge of steel wire suitable for forming a fish hook, that is wound into a pair of side by side loops and has a center slot or hole between adjacent loop surfaces that is to receive a knotted end of a fishing line for mounting the hook or lure swivel eyelet thereto.

Another object of the present invention is to provide a fishing hook or pivot eyelet that is wound as a pair of loops on one end of a straight section of an appropriate gauge of steel wire and has the wire end out turned from the outer loop to pass a section of fishing line that is pulled around the outer loop to between the loops and travels into a hole or slot formed in adjacent loop sides that is parallel to the straight section of steel wire.

Another object of the present invention is to provide for forming the pair of loops by winding an end of a straight section of an appropriate gauge of steel wire into side by side loops, with, prior to which winding, the wire is slotted on at least one side at an appropriate location to be at a top of one of the loops, forming a slot.

Still another object of the present invention is to provide, prior to the winding of the straight section of steel wire into the two loops, for forming slots or grooves on opposite sides of the straight section of steel wire at selected locations from the wire top end that will be in the top of each loop and align to form the hole that is parallel to the lower portion of the straight section of wire.

Still another object of the present invention is to provide a fish hook or swivel eyelet that is simple to mount and dismount to a fishing line having a knotted end.

### BRIEF DESCRIPTION OF THE DRAWINGS

These and other objects and features of the present invention will become more apparent from the following description in which the invention is described in detail in conjunction with the accompanying drawings:

FIG. 1 is a profile top plan perspective view taken from a barb hook end of a fish hook having an eyelet end of the invention;

FIG. 2A is an enlarged top plan view of the eyelet of FIG. 1 sans an opening between a adjacent eyelet loops;

FIG. 2B is a view like that of FIG. 2A only showing a left loop as having been notched;

FIG. 2C is a view like that of FIG. 2A only showing a right loop as having been notched;

FIG. 2D in also a view like that of FIG. 2A only showing the left and right loops as having been notched and with the notches aligned to form a hole;

FIG. 3A shows a perspective view taken above and to the right of a pipe that is shown as having had a section of notched steel wire laid at a right angle across the pipe and, arrows A, show the section of wire being wound around the pipe;

FIG. 3B is a view like that of FIG. 3A and additionally shows the section of wire as having been wound around the pipe through a first loop, as illustrated by arrows B;

FIG. 3C is also a view like that of FIG. 3A only showing the wire as being wound through a second loop with the wire shank aligned with the notch on the top of the loop, and showing the section of wire that has been held stationary during the formation of the first and second loops being bent, shown as arrow C, slightly-out from the pipe at an angle of approximately ninety degrees from the top of the loops, and is then bent away from the first loop, illustrated by arrow D;

FIG. 3D shows the section of wire as has been bent away from the first loop in FIG. 3C being cut with a shears, leaving and out turned end, finishing the formation of the eyelet end;

FIG. 3E shows the eyelet end wound on the pipe of FIG. 3D and shows the section of wire, below the eyelet, as having been wound around a larger pipe, forming a hook end, with arrow E illustrating the eyelet and hook ends being slid off of the pipes;

FIGS. 4A through 4D show configurations of the eyelet of FIG. 1 with different shank arrangements;

FIGS. 5A through 5D show the eyelet of FIG. 1 arranged with different configurations of swivels;

FIG. 5E shows eyelets like that of FIG. 1 having shank ends mounted at spaced intervals around a ring;

FIGS. 6A, 6E, 6F and 6G show the eyelet of FIG. 1 fixed onto, respectively, a spinner, a torpedo weight, a pyramid weight, and a ball weight;

FIGS. 6B, 6C and 6D show the eyelet of FIG. 1 mounted through pivots to different configurations of spinners;

FIGS. 7A through 7C show the eyelet of FIG. 1 shank fitted through, respectively, a spinner to a hook pivot, to a fish like bait, and to one end of a spinner that mounts a hook to its opposite end;

FIG. 8 shows the eyelet of FIG. 1 arranged as a head end of a fly type lure; and

FIG. 9 shows the eyelet of FIG. 1 shank end fitted to a lure body that includes feathers and a worm like tail.

### DETAILED DESCRIPTION

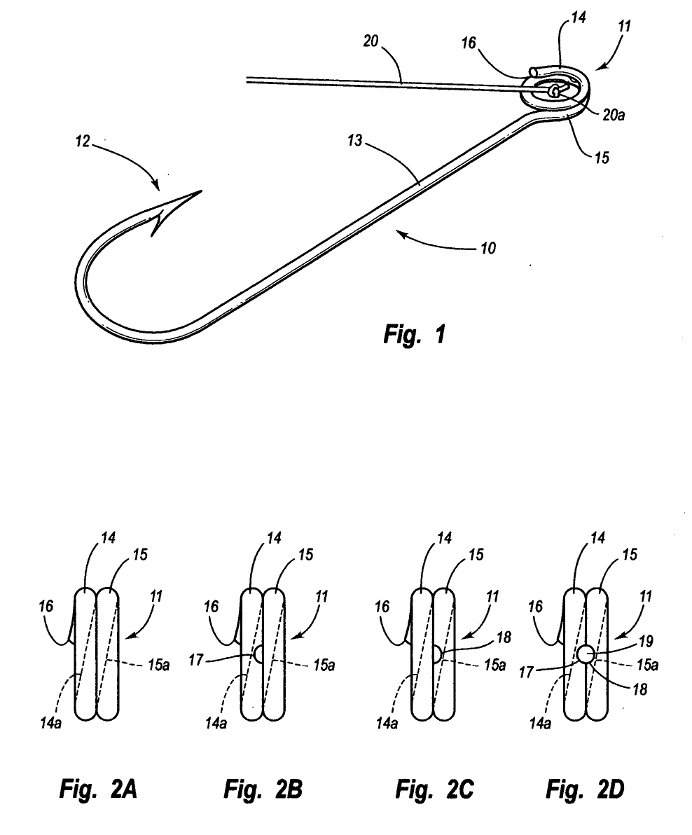

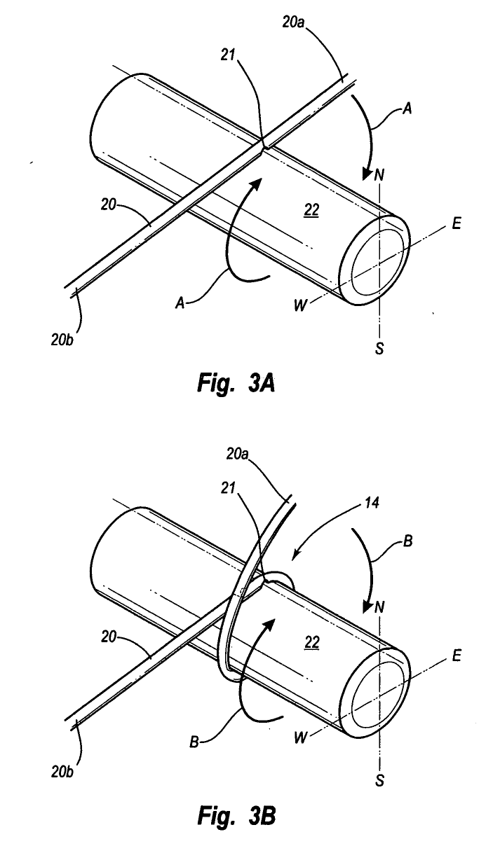

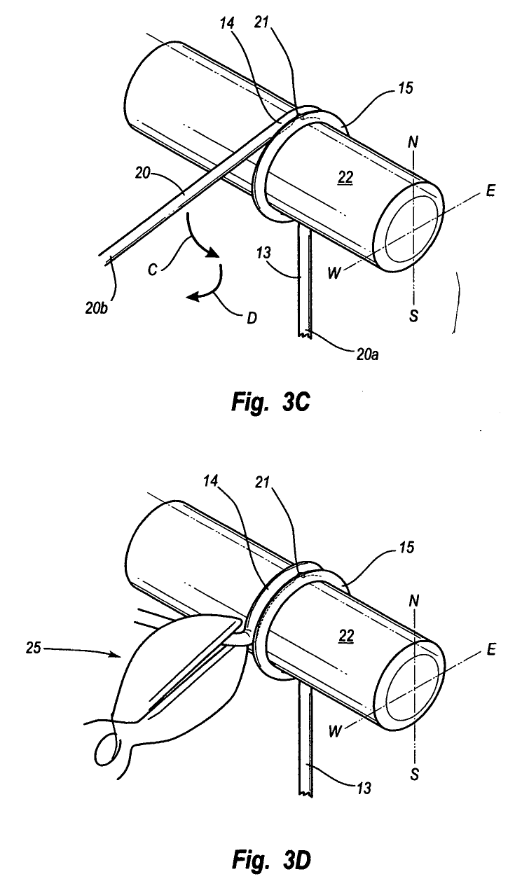

The invention, as is hereinafter described, relates to eyelets that are arranged to be quickly and efficiently mounted onto and dismounted from a knotted end of a fishing line. FIG. 1 shows a perspective view of a fish hook 10 having an eyelet end 11 of the invention as a fish hook top end and includes a barb type hook 12 formed on a lower end with a hook body or shank 13 therebetween. The eyelet 11 is formed having first and second loops 14 and 15, respectively, that are arranged in side by side relationship, and, as shown in FIGS. 2A through 2D, to fit closely together. The first and second loops 14 and 15 are formed by winding a single section of steel wire whose ends are maintained in tension around a rod, as illustrated in FIGS. 3A through 3C, and described below. In which winding, as illustrated in FIG. 2A, identical loops are formed, with the first loop transitioning into the second loop, as illustrated by broken lines 14a and 15a. After which winding an end 16 of loop 14 is formed by out turning the wire and cutting it off a short distance from the loop, with the end 16 then serving to receive a fishing line fitted thereacross and pulled around the loop 14.

The eyelet 11 can be the arrangement shown in FIG. 2A, but preferably includes: a slot 17 formed into the side of loop 14, at the top of the loop, as shown in FIG. 2B; a slot 18 formed into the side of loop 15, at the top of the loop, as shown in FIG. 2C; or has a hole 19 formed by each of slots 17 and 18 that are aligned at the tops of the loops 14 and 15, as shown in FIG. 2D. Which slots 17 and 18 or hole 19 are in the top of the loops 14 and 15 and are essentially parallel to, and just off line from the hook shank 13, and are each to receive a fishing line 20, as shown in FIG. 1. Which fishing line 20 is fitted between the loop 14 end 16 and the loop 14 inner surface and is then pulled around the contacting surfaces of the first and second loops 14 and 15, to intersect the slots 17 and 18, or hole 19, formed in the eyelet loops tops. Whereat, the fishing line 20 is pulled through the slot or hole to where a fishing line knot end 20a engages the slot or hole-edges and binds thereagainst, mounting the eyelet 11 onto the fishing line.

FIGS. 3A through 3D illustrate the steps performed in forming the eyelet 11 utilizing a section of steel wire that is of a gauge that is appropriate for forming a fish hook and a lure swivel, and FIG. 3E illustrates the shank end of the eyelet 11 as being formed into a hook end. FIG. 3A shows a straight section of steel wire of the required gauge for forming a fish hook that has had a notch or groove 21 formed across the wire. The steel wire is shown laid across a pipe or tube 22, with, it should be understood, the steel wire ends maintained under tension. Which pipe or tube 22 is shown with crossing north-south and east-west axes, and shows the notch or groove 21 aligned for contacting the top of the pipe or tube 11, aligned with the north axis. Further, curved arrows A are shown above the pipe or tube 22, illustrating that, with the steel wire end 20b held stationary, the steel wire end 20a is bent around the pipe or tube.

FIG. 3B shows the steel wire end 20a as having been wound around the pipe or tube 22, illustrated by arrows B, making a full loop 14 and starting the second loop 15. FIG. 3C shows the continued winding of the steel wire 22 around the pipe or tube 22, finishing the second loop 15 to where the wire shank end 13 is formed and extends on a parallel line to a line drawn through the slot 21. With FIG. 3C further showing the steel wire 22 as having been bent downwardly to approximately forty five degrees from the top of loop 14, illustrated by arrow C, and is then bent outwardly, illustrated by arrow D. Which bends illustrated by arrows C and D are shown in FIG. 3D that shows the steel wire 22 as being cut with a shear 25 adjacent to the outward bend, as illustrated by arrow D, forming the eyelet end 11, as shown in FIG. 1.

FIG. 3E shows the eyelet 11 formed as described above with respect to FIGS. 3A through 3D maintained on the pipe or tube 22 and showing the steel wire end 20b as having been bent around a greater diameter tube 26 and an end thereof formed into a point 27, and shows, as illustrated by arrow E, the newly formed fish hook being pulled off the pipes 22 and 26. Which formed fish hook is like the fish hook 10 of FIG. 1, to include the eyelet 11, shank 13 and pointed end 27, and which pointed end 27 is formed into a barb, as by stamping, to form the hook barbed end 12, and with the notch or groove 21 formed as shown in FIG. 3A, becoming the slot 17 of FIG. 2B. Further, where the single notch or grove 21 is shown formed across the steel wire 22 in FIG. 3A, forming the first loop 14 of FIG. 3B, it should be understood that such notch or groove can be formed to be at the top of the loop 15 of FIG. 3C, thereby forming the eyelet 11 of FIG. 2C with slot 18. Also, it should be understood that, two spaced notches or grooves 21 can be formed across opposite sides of the steel wire 22 that, when aligned with one another when the first and second loops 14 and 15 are formed, as described above, form the hole 19 through eyelet 11 of FIG. 2D.

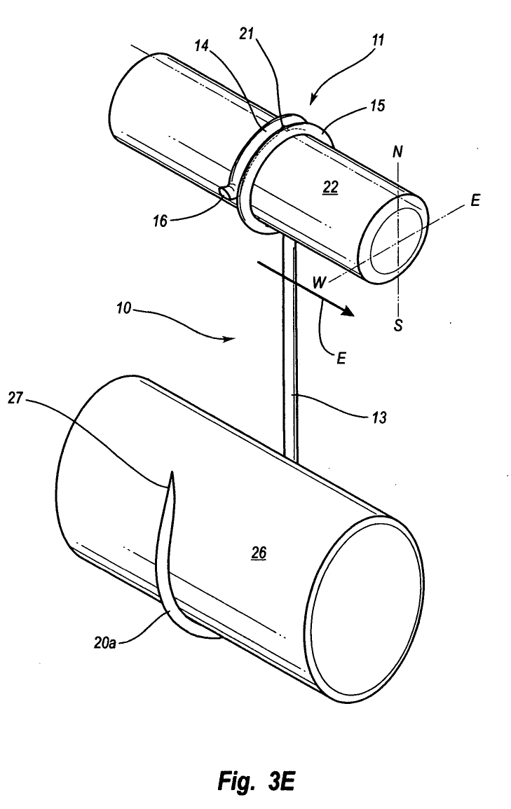

Hereinabove has been shown in FIGS. 1 and 2A through 2D a single fish hook 10, with its method of manufacture shown and described with reference to FIGS. 3A through 3E. FIGS. 4A through 4D each include the eyelet 11 but have different arrangements of shanks 30, 31, 32 and 33, respectively, for arrangement with different fishing lure configurations.

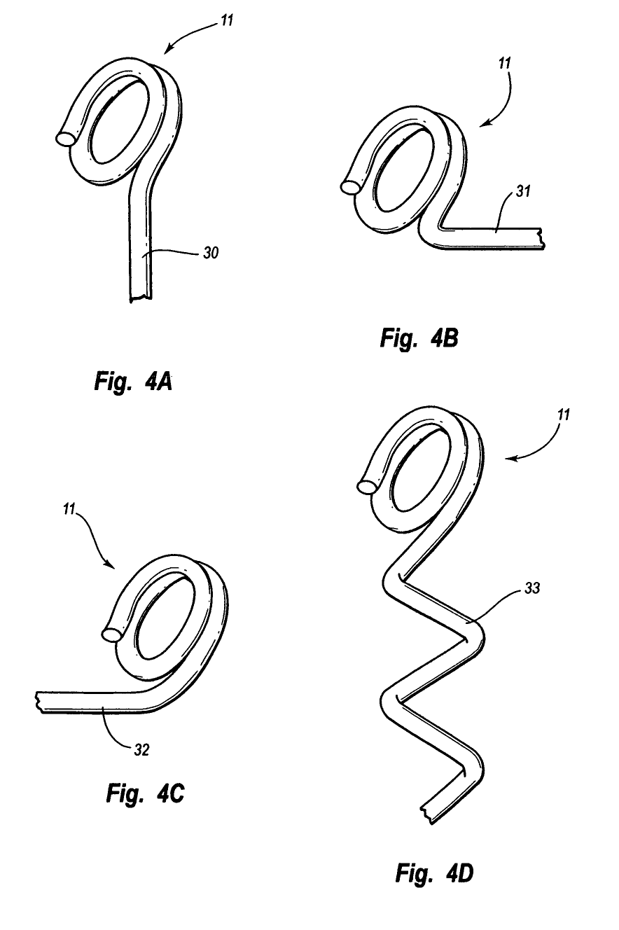

FIGS. 5A and 5C through 5D also show different uses of the eyelet 11 for swivels where the eyelet 11 is connected through a pivot 35 to different configuration of bait holding clips 36, 37 and 38, respectively, and with the eyelet of FIG. 5B shown connected through swivel 35 to a second eyelet 11. FIGS. 5A through 5D show examples of the varied uses of the eyelet 11 of the invention. With, in FIG. 5E eyelets 11 are shown fixed at their shank 12 ends, at spaced intervals around a ring 39, as a further example of the uses the eyelet 11.

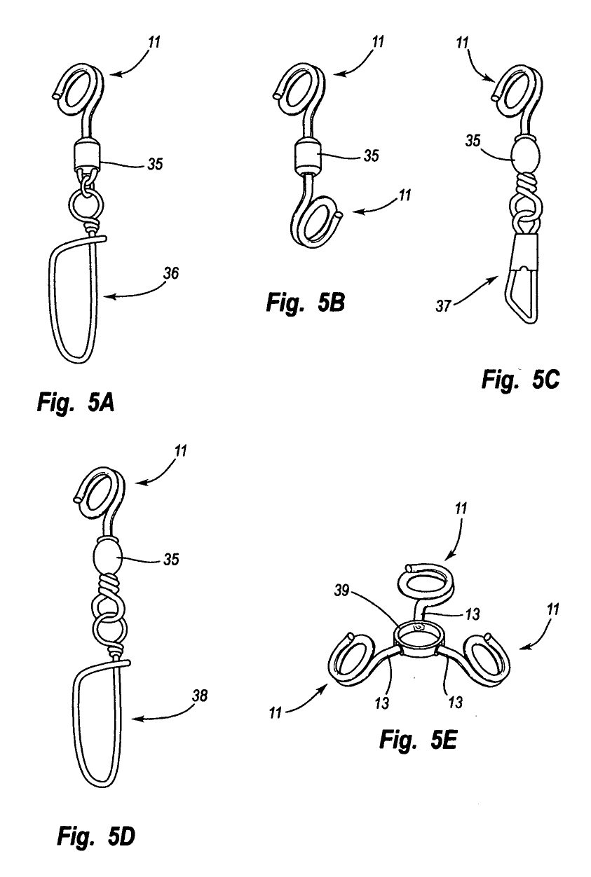

FIGS. 6A and 6B show the eyelet 11 incorporated with disks 40 and 41, respectively. Which arrangement in FIG. 6A has the eyelet 11 fixed to a neck end of the disk 40 and, in FIG. 6B, the eyelet 11 is fitted to a swivel 42 that is attached to a neck end of the disk 41. FIG. 6C shows the eyelet 11 connected through a first linkage 44 to a reflecting device 45 that has its base connected through a second linkage 46 to a second eyelet 11, providing for mounting the reflecting device 45 into a fishing line. Like the arrangement of FIG. 6C, a lure arrangement 47 is shown in FIG. 6D with a top eyelet 11 that is connected through a first swivel 47 to a spinning reflective device 48 that, in turn, connects on its bottom end to a second swivel 49 that, mounts to a bottom eyelet 11. The top and bottom eyelets 11 provide for attaching the spinning reflective device 48 into a fishing line.

FIGS. 6E through 6G show arrangements of the eyelet secured to weights. With FIG. 6E showing a pair of top and bottom eyelets 11 mounted to ends of a weight 51 for mounting in a fishing line. A single eyelet 11 is shown mounted onto a base of a pyramid weight 52 in FIG. 6F, and a single eyelet 11 is shown fitted into a ball weight 53 in FIG. 6G.

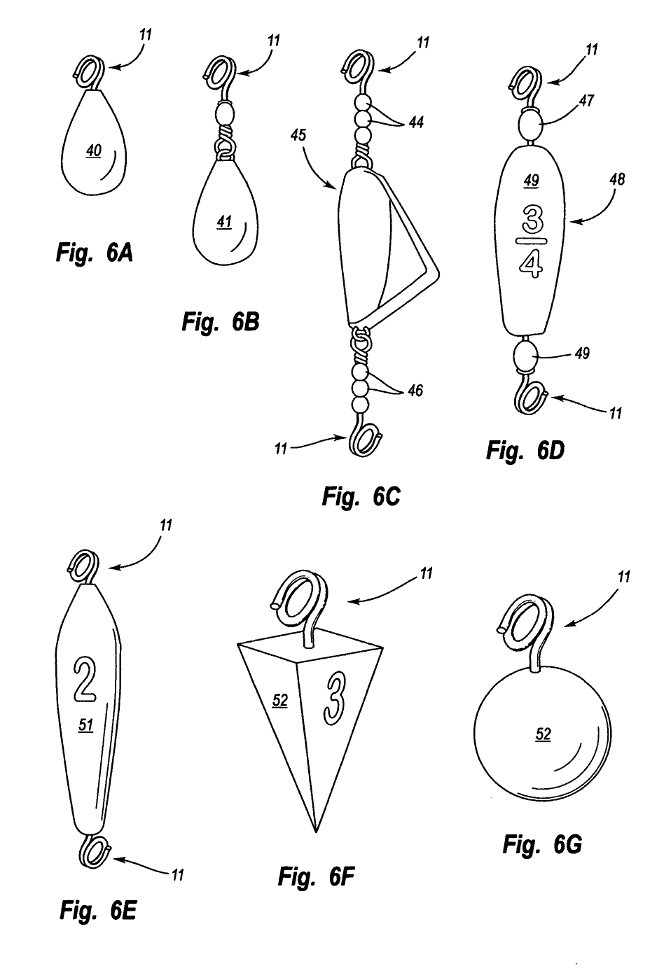

To further illustrate uses of the eyelet 11, FIG. 7A shows the eyelet 11 as having its shank 13 fitted through a reflecting disk 53 and with the shank shown as having had its lower end connected to a weight 54 that has a loop 55 fitted in its rear end that mounts an end of a treble hook 56. Similar to the arrangement of FIG. 7A, FIG. 7B shows the eyelet 11 shank 13 fitted through a reflecting disk 57, is passed through beads 58 and mounts onto an end 59 of a hook that is passed through a minnow 60 with a hook barbed end 61 passed out through the minnow 60 belly. FIG. 7C shows an eyelet 11 that has its shank 13 end fitted into a pivot collar 63 that is mounted in the bow end of a disk 62 whose stern end has a hole 64 formed therethrough that a treble hook 65 is mounted to. FIGS. 7A, 7B and 7C are here included to further show the multitude of uses that the eyelet 11 is suited for.

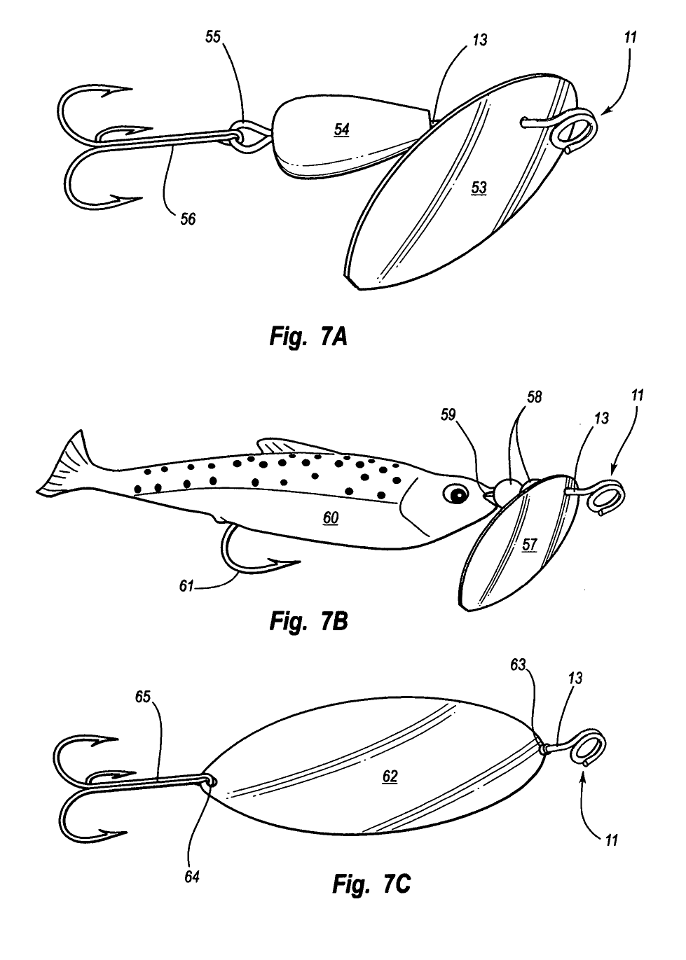

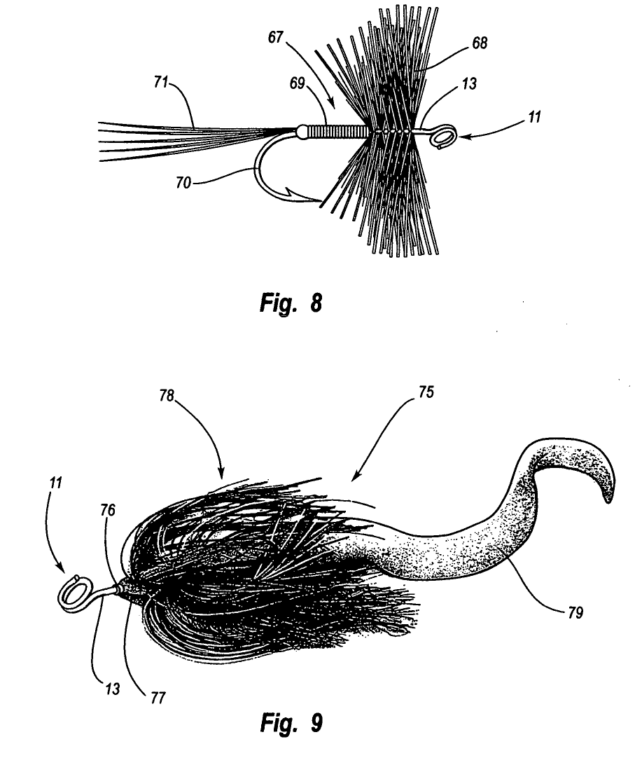

Finally, to further demonstrate the many-uses of the eyelet 11, FIG. 8 shows the shank 13 of an eyelet 11 arranged to function as a forward portion of a fly type lure 67, that includes hairs or feathers 68 connected to the shank 13, ahead of a body 69 to resemble an insect body, and includes a barbed hook end 70, with feathers 71 extending rearwardly from which body 69 rear end. With, in FIG. 9, the eyelet 11 shank 13 end is shown fitted into a pivot collar 76 of a fish lure 75 that includes a mid-body section 78 with feathers or threads extending therefrom, and includes a worm like tail 79. Which FIGS. 8 and 9 are here includes to show finished fishing lure arrangements that utilize the eyelet 11, demonstrating its versatility.

Hereinabove has been set out a description of a preferred embodiment of the fish hook and lure swivel eyelet and method for manufacture of the invention. It should however, be understood that the present invention can be varied within the scope of this disclosure without departing from the subject matter coming within the scope of the following claims, and a reasonable equivalency thereof, which claims I regard as my invention.

1. A fish hook or lure swivel eyelet comprising a single section of steel wire of a gauge that is appropriate to form a fish hook or swivel eyelet whose end portion is laterally slotted a selected distance back from a forward end and is wound into a pair of side by side loops so that said slot is positioned at the top of the loop that is formed in said section of steel wire and said slot is parallel to a lower portion of said section of steel wire; and said lower portion of said single section of steel wire is formed into a hook end or is attached to a pivot as a swivel eyelet.

2. The fish hook or lure swivel eyelet as recited in claim 1, where the upper portion of the single section of section of steel wire is laterally slotted at selected spaced intervals so that, when the side by side loops are formed in said single section of steel wire, said slots align, forming a single lateral hole between opposing loop surfaces, and said single lateral hole is essentially parallel to a lower portion of said single section of steel wire.

3. The fish hook or lure swivel eyelet as recited in claim 1, wherein an upper end of the single section of steel wire is out turned from an adjacent loop to accommodate a fishing line pulled thereunder.

4. A method for manufacturing a fish hook consisting of, selecting a straight section of steel wire of a gauge that is appropriate to form a fish hook or lure swivel eyelet and forming at least one lateral slot thereacross at a selected spaced distance from a upper end of said straight section of steel wire; winding an upper end of said straight section of steel wire into a pair of side by side first and second loops where the lateral slot is at atop of one said loop and is adjacent to the other said loop, and which said slot is essentially parallel to a lower portion of said straight section of steel wire; and forming said lower portion of said straight section of steel wire into a barbed hook end.

5. The method as recited in claim 4, wherein a pair of spaced lateral slots are formed across opposite sides of the upper portion of the straight section of steel wire such that, when the pair of side by side by side first and second loops are formed, the two slots will align, forming a hole, that is on the top of said loops and is essentially parallel to the lower portion of said section of wire.

6. The method as recited in claim 4, further including maintaining the upper and lower portions of the straight section of wire in tension as said wire is wound around a rod, forming the side by side first and second loops around said rod; and bending said straight section of wire at the bottom of said second loop to where it is essentially parallel to the slot formed between the loops; and forming a barbed hook end in a bottom end portion of said section of wire.

7. The method as recited in claim 6, wherein the upper end of the straight section of wire is bent outwardly from the first loop.

8. The method as recited in claim 6, wherein the barbed hook end is formed in the bottom end portion of said section of wire by stamping.

9. A method for manufacturing a lure swivel eyelet consisting of, selection of a straight section of steel wire of a gauge that is appropriate to form a fish hook or lure swivel eyelet and forming at least one lateral slot thereacross at a selected spaced distance from an upper end thereof; winding an upper end of said straight section of steel wire into a pair of side by side first and second loops where the lateral slot is at a top of one said loops and is adjacent to the other said loop, and which said slot is essentially parallel to a lower portion of said straight section of steel wire; and forming said lower portion of said straight section of steel wire into a lure swivel eyelet by winding it around a pivot.

10. A method as recited in claim 9, wherein a pair of spaced lateral slots are formed on opposite sides of the upper portion of the straight section of steel wire such that, when the pair of side by side first and second loops are formed, the two slots will align, forming a hole, that is on the top of said loops and is essentially parallel to the lower portion of said section of wire.

11. The method as recited in claim 9 further maintaining the ends of the section of wire in tension as the upper end of said straight section of wire is wound around a rod to form the side by side first and second loops around said rod; and bending said straight section of wire at the bottom of said second loop to where it is essentially parallel to the slot formed between the loops; and winding a bottom end portion of said section of wire around a pivot in forming a lure swivel eyelet.

12. The method as recited in claim 11, wherein the upper end of the straight section of wire is bent outwardly from the first loop.
